(19) United States
(12) Patent Application Publication
(10) Pub. No.: US 2026/0105364 A1
(43) Pub. Date: Apr. 16, 2026

(54) MACHINE LEARNING TRAINING FOR CHARACTERIZING WATER INJECTION AND SEISMIC PREDICTION

(71) Applicant: SCHLUMBERGER TECHNOLOGY CORPORATION, Sugar Land, TX (US)

(72) Inventors: Adam Niven SHUMAKER, Houston, TX (US); Kaustubh SHRIVASTAVA, Houston, TX (US)

(21) Appl. No.: 19/113,017

(22) PCT Filed: Sep. 14, 2023
(86) PCT No.: PCT/US2023/032719

§ 371 Date: Mar. 19, 2025

Related U.S. Application Data
(60) Provisional application No. 63/408,092, filed on Sep. 19, 2022.

(51) Int. Cl. G06N 20/00; E21B 41/00

(52) U.S. Cl. CPC G06N 20/00; E21B 41/0057; E21B 2200/20; E21B 2200/22

(57) ABSTRACT

A method including receiving a reservoir model of a target under-ground region. The method also includes extracting, from the reservoir model, a historic pressure distribution in grid cells of the target underground region. The method also includes extracting, from the reservoir model, distances. Each distance represents a distance between a grid cell and a corresponding lineament in the target underground region. The method also includes receiving historic earthquake data of past earthquakes in the target underground region. The method also includes generating a vector. The vector includes features and corresponding values for at least i) the historic pressure distribution, ii) the distances, and iii) the historic earthquake data. The method also includes training a trained machine learning algorithm by recursively executing a machine learning algorithm on the vector until convergence.

### RELATED APPLICATIONS

This application claims priority to U.S. provisional patent application Ser. No. 63/408,092, filed Sep. 19, 2022, the entirety of which is hereby incorporated by reference.

### BACKGROUND

Subsurface water may be produced during oil and gas production, either from already existing subsurface water or previously injected water. Disposing of the produced water (sometimes called wastewater) is challenging. One technique for disposing of produced water is through reinjection of the produced water below the surface of the Earth.

However, reinjection can lead to an increase in the pressure in one or more subsurface formations. As a result, earthquake activity may increase. In turn, increased earthquake activity can have an impact on the environment and add uncertainty to design and planning decisions.

Predicting earthquakes using reservoir models is computationally expensive. Thus, an undesirable amount of time may be used to perform a number of desired earthquake predictions based on selected variations in water disposal plans. Additionally, predictions using models often miss variables, or cannot account for variables due to missing or unavailable data, thereby rendering the predictions undesirably inaccurate.

Predicting earthquakes using machine learning algorithms is impractical because of the inability to generate a vector that correlates relevant data to earthquake events, and in some cases, the volume of data in a reservoir model. A data scientist cannot merely vectorize a reservoir model and then input the reservoir model into a machine learning algorithm to predict earthquakes. Additionally, machine learning algorithms cannot be properly trained without the relevant data. Thus, again, machine learning algorithms often fail to generate accurate predictions of earthquake events.

### SUMMARY

One or more embodiments are directed to a method. The method includes receiving a reservoir model of a target underground region. The method also includes extracting, from the reservoir model, a historic pressure distribution in grid cells of the target underground region. The method also includes extracting, from the reservoir model, distances. Each distance represents a distance between a grid cell and a corresponding lineament in the target underground region. The method also includes receiving historic earthquake data of past earthquakes in the target underground region. The method also includes generating a vector. The vector includes features and corresponding values for at least i) the historic pressure distribution, ii) the distances, and iii) the historic earthquake data. The method also includes training a trained machine learning algorithm by recursively executing a machine learning algorithm on the vector until convergence.

Other aspects of one or more embodiments will be apparent from the following description and the appended claims.

### BRIEF DESCRIPTION OF DRAWINGS

FIG. 1.1 and FIG. 1.2 shows a computing system, in accordance with one or more embodiments.

FIG. 2.1, FIG. 2.2, and FIG. 2.3 show flowcharts of methods using the computing system of FIG. 1.1, in accordance with one or more embodiments.

FIG. 2.4 shows a diagram of a machine learning framework that may be used, in accordance with one or more embodiments.

FIG. 2.5, FIG. 2.6, and FIG. 2.7 show flowcharts of methods using the machine learning framework of FIG. 2.4, in accordance with one or more embodiments.

FIG. 2.8 shows an example ensemble model, in accordance with one or more embodiments.

FIG. 3.1, FIG. 3.2, FIG. 3.3, FIG. 3.4, FIG. 3.5, FIG. 3.6, FIG. 3.7, FIG. 3.8, FIG. 3.9, FIG. 3.10, and FIG. 3.11 show an example, in accordance with one or more embodiments.

FIG. 4.1 and FIG. 4.2 show a computing system and a network environment, in accordance with one or more embodiments.

Like elements in the various figures are denoted by like reference numerals for consistency.

### DETAILED DESCRIPTION

In general, one or more embodiments describe techniques for training one or more machine learning algorithms to predict future seismic events (e.g., earthquakes) based on selected values of reinjection of produced water under the Earth. Thus, one or more embodiments may be directed towards improving a machine learning algorithm to be capable of more accurate earthquake prediction. The training techniques of one or more embodiments also may increase the computing efficiency of earthquake prediction.

As indicated above, technical problems exist in computerized prediction of earthquakes associated with reinjection of produced water. One or more embodiments may address the technical problems via a technical solution. Briefly, the technical solution is an improved method of training one or more machine learning algorithms. The result of training is a machine learning algorithm that is capable of generating a relatively accurate earthquake predictions over the extent of an underground region.

In more detail, one or more embodiments may present a hybrid prediction method. The hybrid prediction method begins with detailed reservoir models and extracts specific kinds of relevant data from the reservoir models. The relevant data is combined with historic earthquake data into a vector. The vector can then be used to train one or more machine learning algorithms that predict the probabilities of earthquakes at various grid cells (locations) across a target underground region. Extraction of the relevant features from the reservoir model (features that are converted into the vector) is not straightforward, because the reservoir model is both complex and contains a variety of data. It is difficult to distinguish between kinds of data that are relevant and are irrelevant to the earthquake prediction analysis when using historic earthquake data.

In still more detail, one or more embodiments may use the relationship between saltwater injection in an underground formation and associated earthquake activity. One or more embodiments may leverage petrotechnical and machine-learning based workflows to characterize earthquakes. One or more embodiments may use information such as geocellular reservoir properties, reservoir simulation data, historical earthquake information, and proprietary semiregional three dimensional (3D) seismic data. A semiregional static reservoir model is constructed based on well control and facies maps. Porosity-permeability properties are propagated using a machine learning assisted property modeling engine. History matching is used to account for historic saltwater disposal in the disposal wells located in the formation, and the induced pore pressure is modeled. The trained machine learning algorithm considers relevant features at each node in the model, such as reservoir pressure, proximity of known faults, karst features, and stress orientation.

One or more embodiments therefore may present a hybrid method to holistically analyze reservoir data, along with injection information and 3D seismic data, and leverage machine learning to extract insights from the historical earthquake data and association of the earthquake data with reservoir conditions and fault traces. The results generated by one or more embodiments may substantiate the presence of deep fracture networks that may cause pressure diffusion and are in line with earthquake observations away from faults assessed from 3D seismic data.

One or more embodiments may provide a machine learning algorithm that may analyze historic data and generate an earthquake probability map that reflects the probabilities of earthquakes at different locations within the target underground region. The approach can be used as a guidance tool for planning injection wells and schedules that minimize the probability and severity of earthquakes that result from water reinjection during oil and gas exploration and production. Thus, one or more embodiments also may be used to generate and then implement improved wastewater disposal plans.

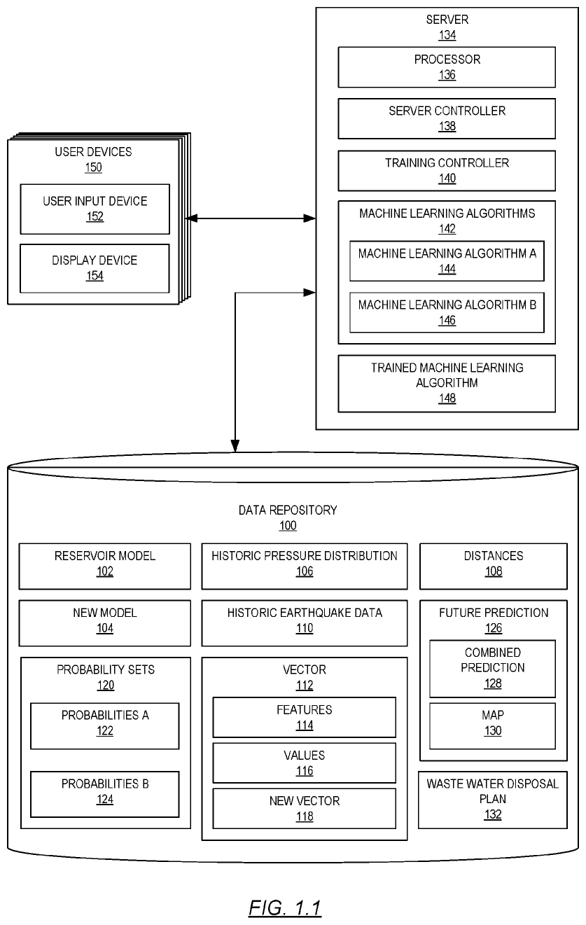

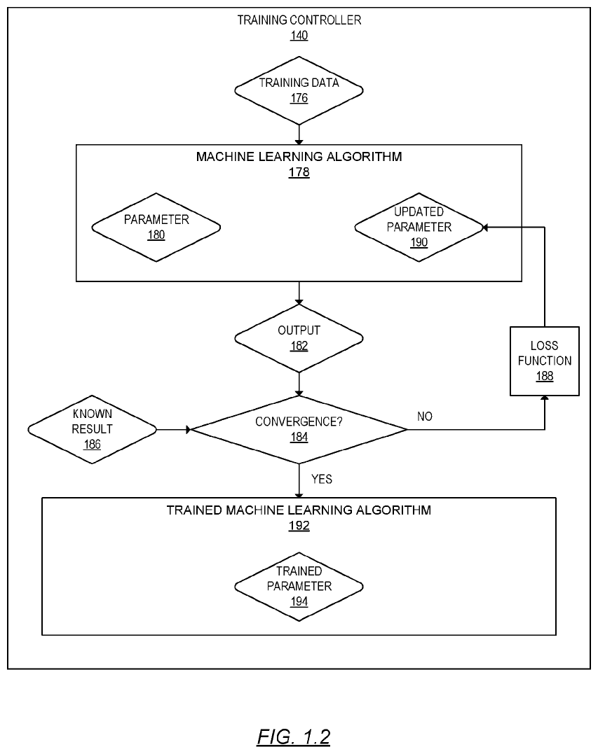

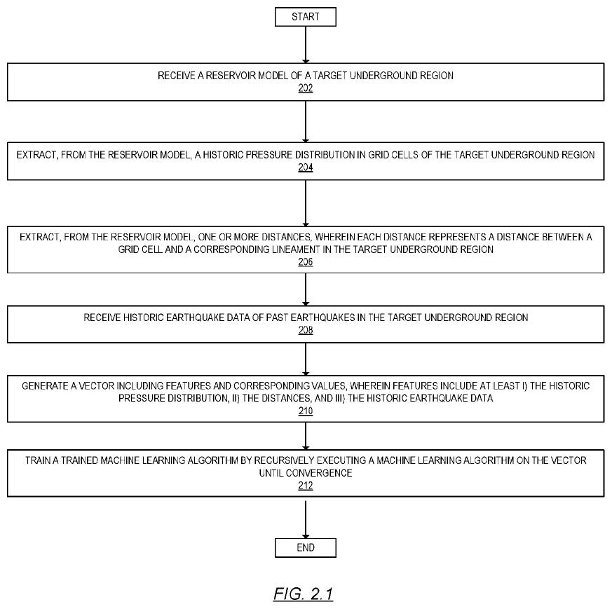

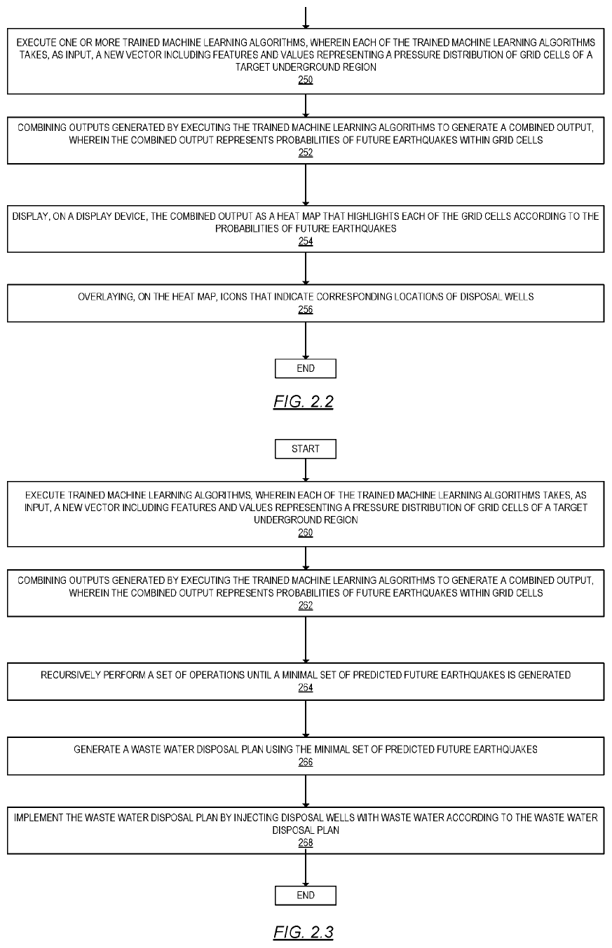

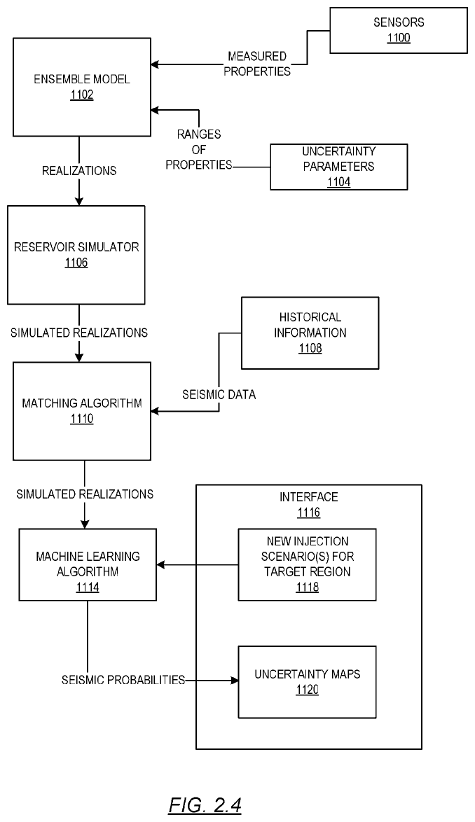

Attention is now turned to the figures. FIG. 1.1 shows a computing system, in accordance with one or more embodiments. The system shown in FIG. 1.1 includes a data repository (100). The data repository (100) is a type of storage unit and/or device (e.g., a file system, database, data structure, or any other storage mechanism) for storing data. The data repository (100) may include multiple different, potentially heterogeneous, storage units and/or devices.

The data repository (100) stores a reservoir model (102). The reservoir model (102) is a data structure that stores information that describes physical properties of a target underground region. The target underground region is a physical subsurface volume of the Earth and may be many miles in extent. The reservoir model (102) may relate historic subsurface attributes and subsurface features to historic water injection in multiple grid cells of the target underground region. In the reservoir model, each grid cell of the reservoir model has a corresponding location in the geographic region. The grid cell maintains one or more properties or attributes for the corresponding location.

There are many different types of reservoir models. Geological models provide a static description of a reservoir (e.g., a target underground region). Reservoir simulation models use finite difference methods to simulate the flow of fluids within the reservoir. However, because each category of model may have many different types of information, or model different properties of a target underground region, potentially many reservoir models may exist for one target underground region.

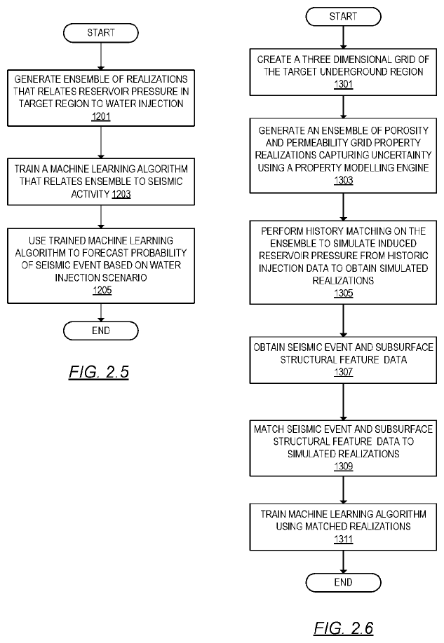

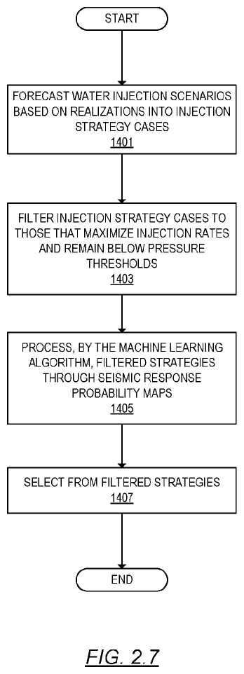

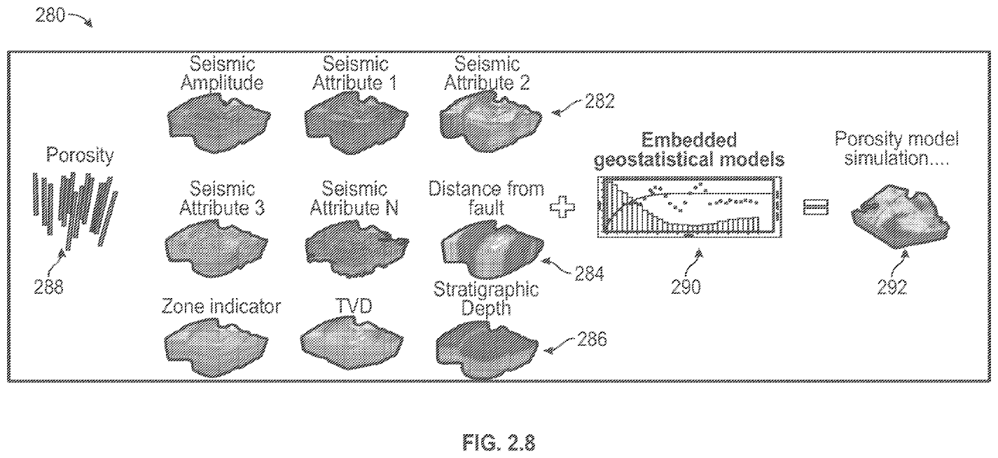

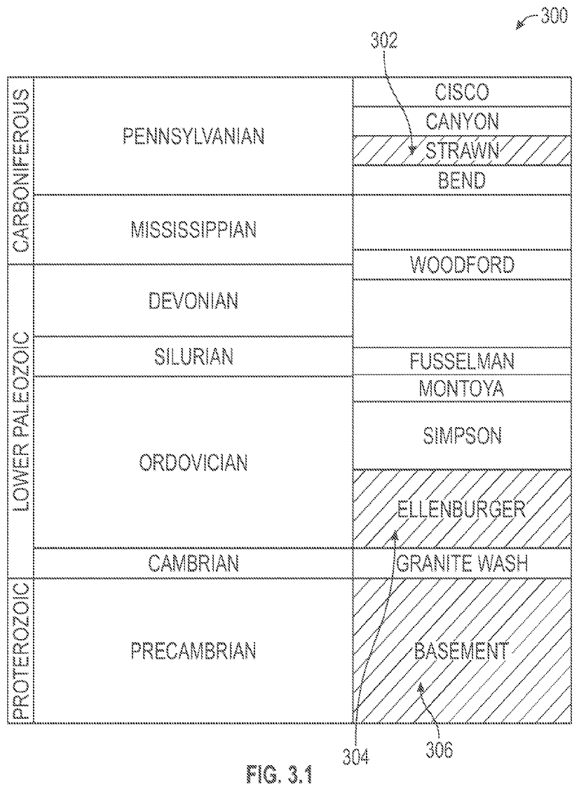

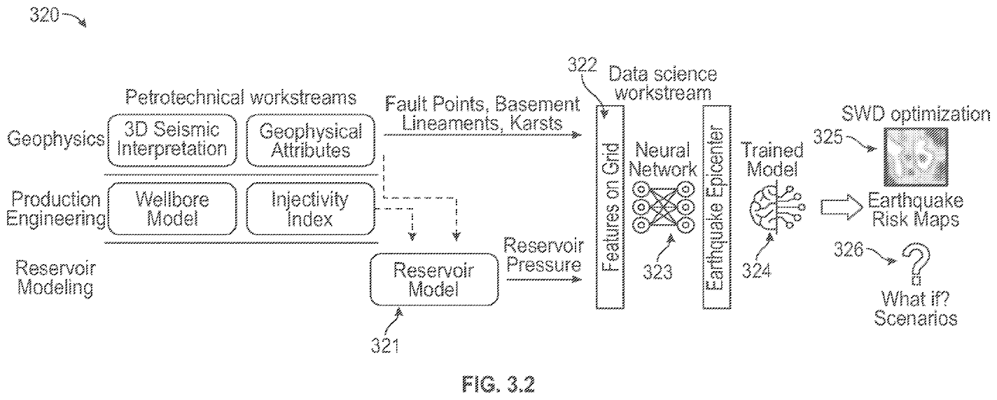

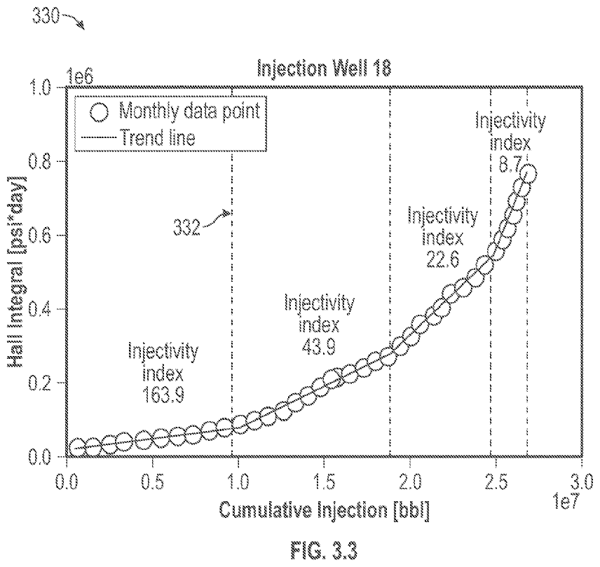

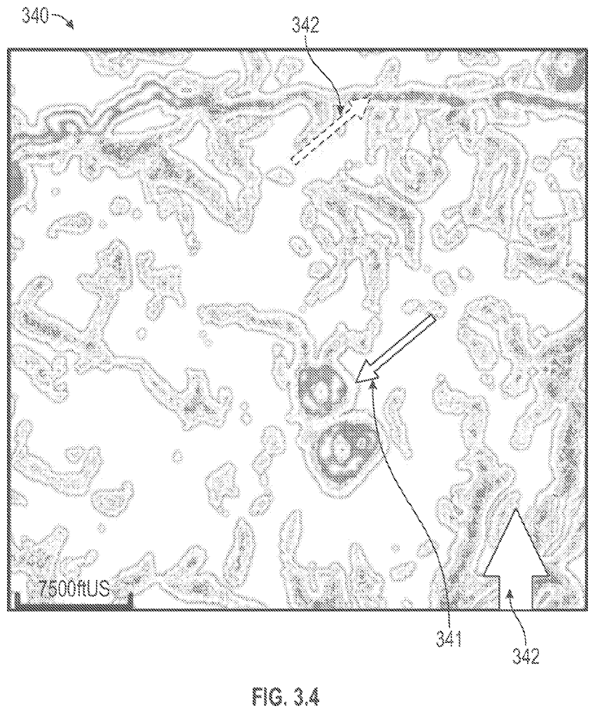

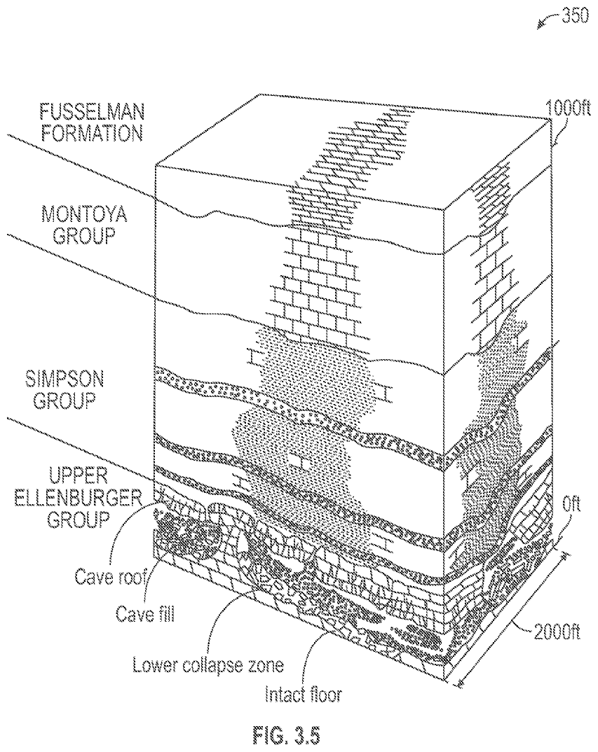

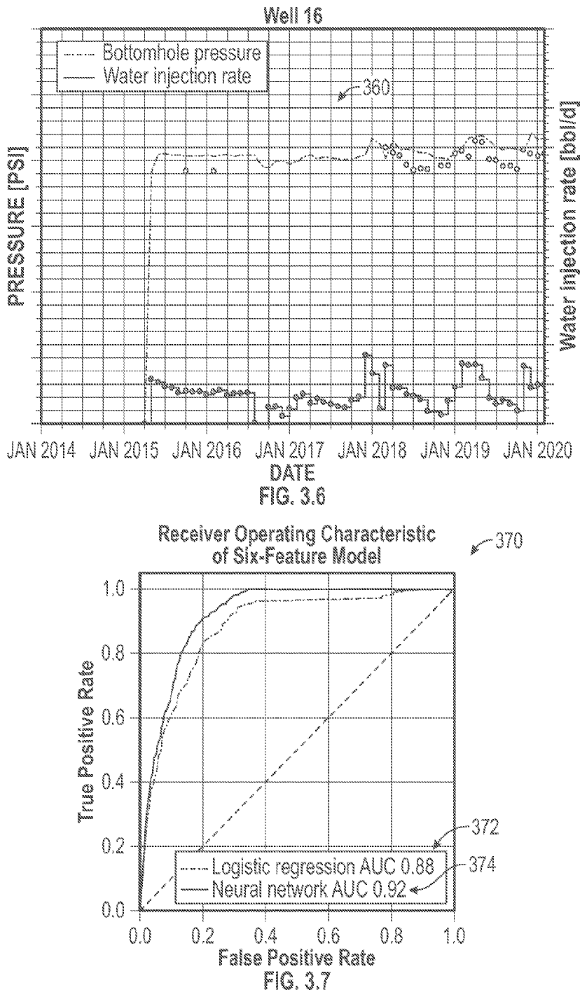

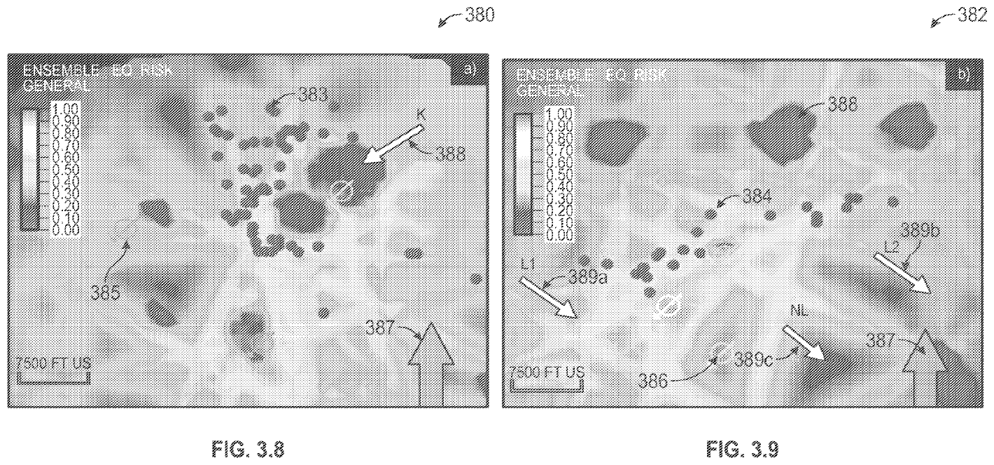

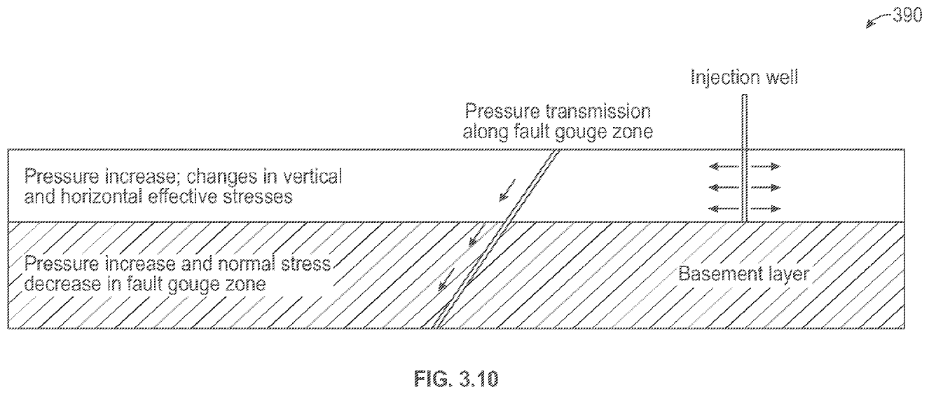

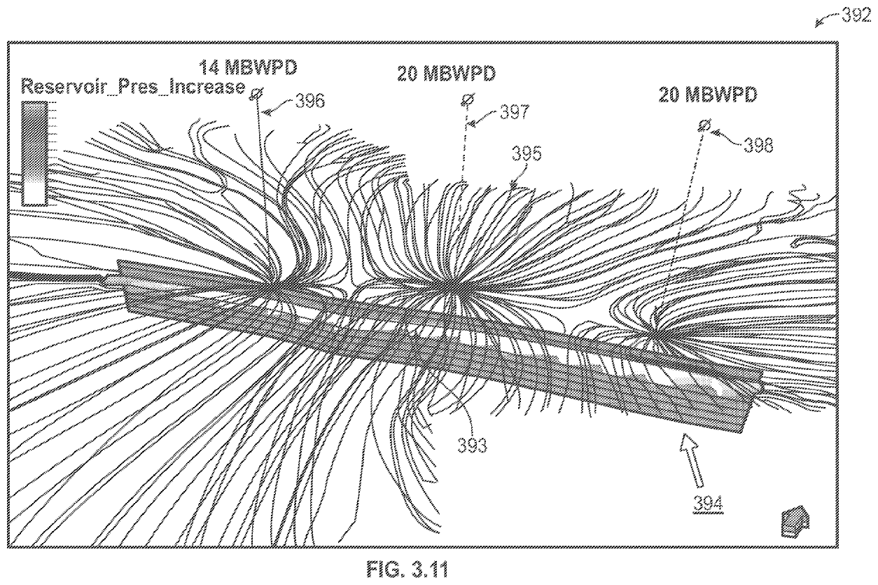

Therefore, while one or more embodiments refer to “a” reservoir model (e.g., the reservoir model (102)), the term a reservoir model automatically contemplates the possibility that many different reservoir models are being drawn upon during the techniques of one or more embodiments, such as those described with respect to FIG. 2.1 through FIG. 3.11. Accordingly, the reservoir model (102) may refer either one reservoir model or to many different reservoir models which are drawn upon during the methods described herein.

In one or more embodiments, the reservoir model (102) may relate historic subsurface attributes and subsurface features to historic water injection in grid cells of the target underground region. Historic water injection is a record of where, how much, and at what pressure water was injected into the target underground region.

The historic subsurface attributes may include physical properties such as pressure, temperature, density, composition of matter, etc. The subsurface features may be faults, karst, lineaments, etc. A lineament is a linear feature in an underground region which is an expression of an underlying geological feature. An example of a lineament is a fault. A fault is a fracture in the rocks of the Earth's crust, where compressional or tensional forces may cause relative displacement of the rocks on the opposite sides of the fracture. Karst is an area of the Earth made of limestone.

The data repository (100) also may store a new model (104). The new model (104) is a model, such as those described herein with respect to the reservoir model (102). However, the new model (104) refers to a model that a trained machine learning algorithm takes as input as part of generating a prediction of future earthquakes (e.g., the new model (104) is used as part of analyzing a “what if” scenario). Thus, the new model (104) may represent variations in the reservoir model (102) for which a geologist would like to receive a hypothetical prediction of future earthquakes if the new model (104) were used. Thus, the new model (104) may, or may not, be the same model as the reservoir model (102). For example, the new model (104) may contain different parameters, such as well locations, pressure distributions, etc.

For example, a geologist may generate a new wastewater disposal plan (see FIG. 3.11) which injects waters at a variety of different wells at a variety of different pressures and rates. The wastewater disposal plan is used to generate a new model (e.g., the new model (104)) of the target underground region, assuming the new hypothetical well locations and water injection pressures and rates. One or more embodiments may then use the data extraction and vectorizations described herein to generate a new vector. The new vector is then provided to the trained machine learning algorithm to generate an earthquake prediction.

A distinction is made between a model and a machine learning algorithm. For some embodiments, a model is a data structure that contains information that describes or relates to a target underground region. A machine learning algorithm is decribed more formally below, but briefly, a machine learning algorithm is the architecture, code, and settings of a computer executable program that is programmed to perform a computer task (e.g., classification, prediction, etc.) by recognizing hidden patterns in data. Thus, as used herein, a machine learning algorithm may take a model as input, but a model is not executable to perform machine learning functions.

A machine learning algorithm is equivalent to a machine learning model, with respect to the technical field of machine learning. However, in order to avoid confusion with the use of the term model herein, one or more embodiments use the term machine learning algorithm rather than the term machine learning model.

The data repository (100) also may store a historic pressure distribution (106). The historic pressure distribution (106) may be a distribution of historical values of fluid pressures in each of many different grid cells of the target underground region. The fluid pressures are pressure values of water as the water was historically injected into one or more water disposal wells in the target underground region.

A grid cell is a virtual area of the target underground region, as described within the reservoir model (102). Various physical properties may be associated with each grid cell. In the case of the historic pressure distribution (106), the historic pressure of past injected water at a grid cell is associated with that grid cell. The historic pressure distribution (106) is one of the types of information that is extracted from the reservoir model (102) for use in the training procedure described with respect to FIG. 2.2.

The data repository (100) also stores one or more distances (108). The distances (108) represent distances between the grid cell of the reservoir model and a corresponding lineament in the target underground region. A lineament is a subsurface linear physical feature that represents a change in the topographical data of the target underground region. An example of a lineament is a fault.

The data repository (100) also stores historic earthquake data (110). The historic earthquake data (110) is data that describes past earthquakes that physically occurred in the target underground region. The historic earthquake data (110) may include information such as epicenter location within the target underground region, times the earthquake(s) occurred, a seismic graph of the earthquake over the time, and various other information of interest.

The data repository (100) also stores a vector (112). The vector (112) is a computer-readable data structure. The vector (112) may take the form of an array of features (114) and values (116). Each of the features (114) is a type of information of interest. For example, a feature may be a pressure associated with a selected grid cell. Each of the values (116) may be an entry (number, text string, etc.) which represents a quantitative assessment or measurement of a corresponding feature. In a specific example, the vector (112) may be a one dimensional matrix composed of values, with each value representing one of the features. However, the vector (112) could be a higher dimensional matrix (e.g., a 1×2 matrix, a 2×2 matrix, a 3×3 matrix, or a hypermatrix). The use of the term, vector, herein does not denote the particular storage structure in memory.

In one or more embodiments, the vector (112) may include features and values for at least i) the historic pressure distribution, ii) the plurality of distances, and iii) the historic earthquake data. The vector (112) may therefore represent the result of pre-processing (or data engineering) of the available information in the reservoir model (102) and the historic earthquake data (110) that results in relevant information suitable for input into a trained machine learning algorithm (described below).

The vector (112) may be a new vector (118). The new vector (118) is a vector suitable for use as input to the trained machine learning algorithm, but which contains information for which the probabilities of earthquake occurrence are not known. For example, when a user desires to check the probabilities of earthquakes if the new model (104) were to be implemented, the new vector (118) is generated and then submitted to the trained machine learning algorithm. Because the plan represented by the new model (104) has not been performed yet, the resulting earthquake probabilities are predicted and hence unknown. For convenient reference, this vector is referred to as the new vector (118). The new vector (118) is not unknown in the sense that the information contained therein is not known.

The data repository (100) also stores probability sets (120), which may include probabilities A (122), probabilities B (124), and possibly many other probability sets. Each of the probability sets (120) represents a set of probabilities that future earthquakes will occur in the grid cells of the new model (104) of the target underground region. In an embodiment, there may be a one to one correspondence between probabilities and grid cells (i.e., each grid cell may be associated with one probability).

For any given prediction, it is possible that multiple trained machine learning algorithms are used. For example, as explained below with respect to FIG. 3.1 through 3.11, multiple trained machine learning algorithms may be executed on the new vector (118). The output of each of the trained machine learning algorithms is one of the corresponding probability sets (120). Thus, for example, the probabilities A (122) may be associated with the output of a first trained machine learning algorithm and the probabilities B (124) may be associated with the output of a second trained machine learning algorithm. Later, as explained with respect to FIG. 2.1 and FIG. 2.2, the probability sets (120) may be combined. The combined probabilities may then be displayed as the displayed probabilities that earthquakes may occur at one or more of the grid cells in the new model (104).

The data repository (100) also may store a future prediction (126). The future prediction (126) is a final set of probabilities for grid cells in a grid that represent the likelihood that earthquakes will occur in the future at one or more grid cells in the new model (104). The difference between the future prediction (126) and the probability sets (120) is that the future prediction (126) is the final set of probabilities that are displayed to a user in some manner.

For example, the probabilities A (122) may be a set of probabilities in the probability sets (120) but may not be the final set of probabilities that are output and displayed to a user. As indicated above, some other set of probabilities in the probability sets (120) may be selected, or perhaps selected ones of the probability sets (120) may be combined in some manner before presentation as the future prediction (126).

The future prediction (126) may be an output of the trained machine learning algorithm. However, the future prediction (126) also may be a combined prediction (128). The combined prediction (128) is a combination of the probability sets (120), as explained above.

The future prediction (126) may be displayed on a graphical user interface in the form of a map (130). The map (130) may display the locations of likely future earthquakes, as well as other information related to the target underground region (such as well locations, geological features, surface locations, etc.).

Note that one or more embodiments may use or refer to multiple future predictions. Thus, reference to the future prediction (126) automatically contemplates the multiple future predictions. For example, if multiple scenarios are run using multiple new models, then each generated future prediction may be one of multiple future predictions.

The map (130) also may be a heat map. A heat map uses color or some other highlighting scheme to show the likelihood of earthquakes at each grid cell. For example, grid cells that are not predicted to have future earthquakes (a grid cell probability less than a threshold) may be colored green, those that are somewhat likely to have a future earthquake (a grid cell probability greater than the threshold) may be colored yellow, and those that are considered very likely to have a future earthquake (a grid cell probability greater than a second threshold) may be colored purple. Examples of heat maps are shown in FIG. 3.8 and FIG. 3.9.

The data repository (100) also may store a water disposal plan (132). The water disposal plan (132) is a pre-determined arrangement of parameters used when disposing of produced water by reinjecting the water into the target underground region. The parameters may include the location of one or more disposal wells where water is reinjected, the rate at which the water is reinjected, the pressure at which the water is reinjected, the depth at which water is reinjected, or other physical parameters related to water reinjection. An example of the water disposal plan (132) is shown in FIG. 3.11.

In an embodiment, the water disposal plan (132) may be optimized. An optimized water disposal plan (132) is a plan for which the future prediction (126) of earthquakes is minimized in terms of frequency, intensity, etc., or a plan for which the future prediction (126) of earthquakes is constrained within certain regions of the target underground region.

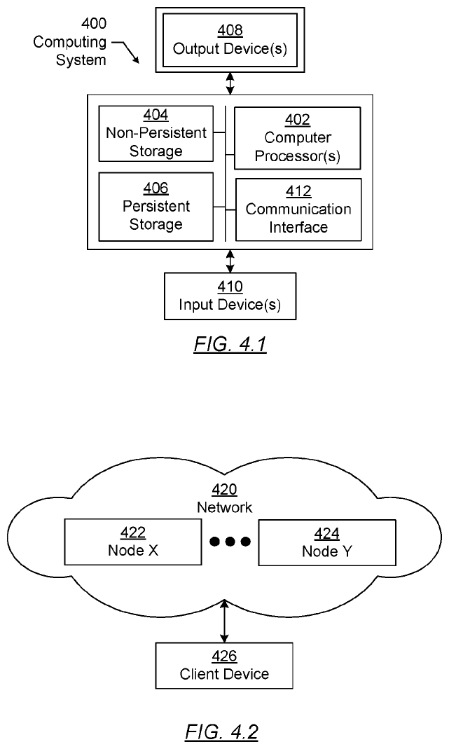

The system shown in FIG. 1.1 also may include a server (134). The server (134) is one or more computing systems operating in a possibly distributed computing environment. The data repository (100) may be local (sharing the same physical location) to the server (134) or may be remote from the server (134). The server (134) may be the computing system, and may include the network environment, of the computing system shown in FIG. 4.1 and FIG. 4.2.

The server (134) includes a processor (136). The processor (136) may be one or more processors, possibly executing algorithms in a distributed computing environment. The processor (136) may be the processor described with respect to FIG. 4.1 and FIG. 4.2.

The server (134) may include a server controller (138). The server controller (138) is hardware or application specific software which, when executed by the processor (136), performs a computer implemented method, such as the methods described with respect to any of FIG. 2.1 through FIG. 2.7.

The server (134) also includes a training controller (140). The training controller (140) is hardware or application specific software which, when executed by the processor (136), trains a machine learning algorithm. An example of the training controller (140) is shown in FIG. 1.2.

The server (134) also includes one or more machine learning algorithms (142), such as machine learning algorithm A (144) and machine learning algorithm B (146). A machine learning algorithm is a computer program that has been trained to recognize certain types of patterns. Many different types of machine learning algorithms exist, though broadly, machine learning algorithms are categorized into supervised and unsupervised machine learning algorithms, which relate to how the machine learning algorithms are trained. A supervised machine learning algorithm is trained based on known data that is compared to the output of the machine learning algorithm during training. An unsupervised machine learning algorithm is trained without known data during training. One or more embodiments may use either supervised or unsupervised machine learning algorithms.

Training a machine learning algorithm changes the machine learning algorithm by changing the parameters defined for the machine learning algorithm. Thus, once changed, a machine learning algorithm may be referred-to as a trained machine learning algorithm. A trained machine learning algorithm is different than the untrained machine learning algorithm, because the process of training transforms the untrained machine learning algorithm. The training may be an ongoing process. Thus, a trained machine learning algorithm may be retrained and/or continually trained. Further, an untrained machine learning algorithm may be a pre-trained machine learning algorithm that has a certain amount of training performed.

In an example, the machine learning algorithm A (144) is a multivariate logistic regression machine learning algorithm, which is a supervised machine learning algorithm. A supervised machine learning algorithm may be used because the historic earthquake data (110) is known, and thus may be used to train the machine learning algorithm A (144) using a supervised machine learning training technique.

In another example, the machine learning algorithm B (146) is an unsupervised machine learning algorithm, such as a neural network. An unsupervised machine learning algorithms may be used where earthquake data is incomplete.

The server (134) also may include a trained machine learning algorithm (148). The trained machine learning algorithm (148) is one of the machine learning algorithms (142) after the training process has been completed. The training process of a machine learning algorithm is described with respect to FIG. 1.2.

The system shown in FIG. 1.1 may include other components. For example, the system shown in FIG. 1.1 may include one or more user devices (150). The user devices (150) each may include a corresponding user input device (152) and a display device (154).

The user input device (152) may be a touch screen, an audio input device, a haptic input device, a mouse, a keyboard, etc. The user input device (152) may be used to provide data to the data repository (100) or to the server (134), or to issue commands to the server (134) to execute the server controller (138), the training controller (140), or any of the machine learning algorithms (142).

The display device (154) is a display device that may display information on a graphical user interface. The display device (154) may be a display screen, monitor, television, speaker, or haptic device. The information may include the data stored on the data repository (100). The information may include widgets that may be used to control any of the server controller (138), the training controller (140), or the machine learning algorithms (142).

Attention is turned to FIG. 1.2, which shows the details of the training controller (140). The training controller (140) is a training algorithm, implemented as software or application specific hardware, that may be used to train one or more the machine learning algorithms described with respect to FIG. 1.1, including the machine learning algorithms (142), the machine learning algorithm A (144), or the machine learning algorithm B (146).

In general, machine learning algorithms are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model (i.e., the trained machine learning algorithms (192)) is applied to the new vector (118) of FIG. 1.1 in order to make predictions.

In more detail, training starts with training data (176), which may be the vector (112) described with respect to FIG. 1.1. The training data (176) is data for which the final result is known with certainty. For example, if the machine learning task is to predict a probability that an earthquake will occur at a particular grid cell in the reservoir model (102) of FIG. 1.1, then the training data (176) may at least include the historic earthquake data (110) of FIG. 1.1. Note that, referring to FIG. 1.1, because the vector (112) includes the historic earthquake data (110), it remains the case that the new vector (118) may be used as the training data (176).

The training data (176) is provided as input to the machine learning algorithm (178). The machine learning algorithm (178), as described before, is an algorithm. However, the output of the algorithm may be changed by changing one or more parameters of the algorithm, such as the parameter (180) of the machine learning algorithm (178). The parameter (180) may be one or more weights, the application of a sigmoid function, a hyperparameter, or possibly many different variations that may be used to adjust the output of the function of the machine learning algorithm (178).

One or more initial values are set for the parameter (180). The machine learning algorithm (178) is then executed on the training data (176). The result is a output (182), which is a prediction, a classification, a value, or some other output which the machine learning algorithm (178) has been programmed to output.

The output (182) is provided to a convergence process (184). The convergence process (184) compares the output (182) to a known result (186). A determination is made whether the output (182) matches the known result (186) to a pre-determined degree. The pre-determined degree may be an exact match, a match to within a pre-specified percentage, or some other metric for evaluating how closely the output (182) matches the known result (186). Convergence occurs when the known result (186) matches the output (182) to within the pre-determined degree.

If convergence has not occurred (a “no” at the convergence process (184)), then a loss function (188) is generated. The loss function (188) is a program which adjusts the parameter (180) in order to generate an updated parameter (190). The basis for performing the adjustment is defined by the program that makes up the loss function (188), but may be a scheme which attempts to guess how the parameter (180) may be changed so that the next execution of the machine learning algorithm (178) using the training data (176) with the updated parameter (190) will have an output (182) that more closely matches the known result (186).

In any case, the loss function (188) is used to specify the updated parameter (190). As indicated, the machine learning algorithm (178) is executed again on the training data (176), this time with the updated parameter (190). The process of execution of the machine learning algorithm (178), execution of the convergence process (184), and the execution of the loss function (188) continues to iterate until convergence.

Upon convergence (a “yes” result at the convergence process (184)), the machine learning algorithm (178) is deemed to be a trained machine learning algorithm (192). The trained machine learning algorithm (192) has a final parameter, represented by the trained parameter (194).

During deployment, the trained machine learning algorithm (192) with the trained parameter (194) is executed again, but this time on the new vector (118) of FIG. 1.1 for which the final result is not known ahead of time. The output of the trained machine learning algorithm (192) is then treated as a prediction of the information of interest relative to the unknown data.

While FIG. 1.1 and FIG. 1.2 show a configuration of components, other configurations may be used without departing from the scope of one or more embodiments. For example, various components may be combined to create a single component. As another example, the functionality performed by a single component may be performed by two or more components.

Attention is now turned to FIG. 2.1, which shows a method of training a machine learning algorithm.

Block 202 includes receiving a reservoir model of a target underground region. While “a” reservoir model is recited in block 202, the reservoir model may be multiple reservoir models, as explained with respect to FIG. 1.1. The reservoir model may be received by either transmitting the reservoir model to a server, or by a server retrieving the reservoir model.

Block 204 includes extracting, from the reservoir model, a historic pressure distribution in the grid cells of the target underground region. The historic pressure distribution may include a historic record of water injected into one or more wells in the target underground region.

The historic pressure distribution may be extracted by the processor performing a query on the reservoir model or models. Alternatively, the historic pressure distribution data already may be available, in which case the historic pressure distribution data is accessed. The historic pressure distribution data may be stored in some other file for later use or may be added to the vector (see block 210, below).

Block 206 includes extracting, from the reservoir model, one or more distances. Again, each distance represents a distance between a grid cell and a corresponding lineament in the target underground region.

Like extracting the historic pressure distribution, extracting the one or more distances may be performed by performing a query on the reservoir model or models. Alternatively, the one or more distances already may be available, in which case the data is accessed. The distances may be stored in some other file for later use or may be added to the vector (see block 210 below).

Block 208 includes receiving historic earthquake data of past earthquakes in the target underground region. Again, the historic earthquake data may include locations of epicenters of past earthquakes, and times the earthquakes occurred.

Receiving the historic earthquake data may be performed by the processor accepting or being commanded to retrieve the historic earthquake data. Again, receiving the historic earthquake data may be performed by storing the historic earthquake data in the vector (see block 210 below).

Block 210 includes generating a vector including features and corresponding values for the plurality of features. The features of the vector include at least i) the historic pressure distribution, ii) the plurality of distances, and iii) the historic earthquake data.

Generating the vector may be performed by a number of different methods. As indicated above, the various information may be converted or stored directly into the vector. Thus, for example, the pressure value for a particular grid identifier in a reservoir model may be stored as the value for the corresponding feature in the vector that represents the grid identifier.

Alternatively, the data extracted at block 204, block 206, and the historic earthquake data received at block 208 may be stored in a separate database, such as a relational database or a graph database. In this case, the separate database may be queried or otherwise fed as input to a vectorization algorithm. A vectorization algorithm may convert the information from the separate database into the vector, entering the values for each feature of the vector based on the data stored in the separate database. For example, the properties generated at block 204, block 206, and block 208 may be concatenated into the vector.

In an embodiment, feature engineering may be performed on the vector generated at block 210. Examples of feature engineering on the vector are described with respect to FIG. 3.1 through FIG. 3.11, and in particular with respect to FIG. 3.2.

Block 212 includes training a trained machine learning algorithm by recursively executing a machine learning algorithm on the vector until convergence. Training may be performed as described with respect to FIG. 1.2. The trained machine learning algorithm, when executed on a new vector derived for the target underground region, is programmed to predict probabilities that future earthquakes will occur in the grid cells of the target underground region.

The method of FIG. 2.1 may be extended. For example, the trained machine learning algorithm may be used. After training, the method also may include receiving a new model of pressure distribution in the grid cells of the target underground region. The new model includes data representing a simulation of new water injected into the disposal wells. The processor then converts the new model into a new vector, which again is a data structure that contains a new pressure distribution in the target underground region and is suitable for input to the machine learning algorithm.

The processor then executes the trained machine learning algorithm on the new vector. An output of the trained machine learning algorithm may be a future prediction of earthquakes in the target underground region.

The future prediction may be reported. Reporting the future prediction may take several different forms. For example, the future prediction may be stored as a data structure (e.g., a data matrix stored in the data repository) for later use. Reporting the future prediction may also include displaying the future prediction on a graphical user interface (GUI). Reporting the future prediction also may include converting the future prediction into a heat map or some other map of the target underground region in which the intensity and locations of predicted earthquakes may be displayed. The heat map then may be displayed on the GUI. Examples of heat maps are shown in FIG. 3.8 and FIG. 3.9.

The method of FIG. 2.1 may be further extended. For example, the method also may include training additional trained machine learning algorithms by recursively training, with the vector and until convergence, additional machine learning algorithms. The additional machine learning algorithms may be a variety of different types of machine learning algorithms, such as a multivariate logistic regression machine learning algorithm, a neural network machine learning algorithm, a random forest machine learning algorithm, and a tree-based machine learning algorithm. The additional trained machine learning algorithms, when executed on a new vector derived for the target underground region, are programmed to predict sets of probabilities that future earthquakes will occur in the grid cells of the target underground region.

In other words, more than one machine learning algorithm may be used to generate multiple sets of predictions for the earthquakes. The results of the predictions may be presented separately. The results of the predictions also may be combined, as described further below, and the combined prediction then presented.

Blocks within the method of FIG. 2.1 also may be varied. For example, the generating the vector may also include other procedures. In a more specific example, generating the vector may include weighting the features to account for known issues that can skew the predictions of earthquakes. Still more specifically, a grid imbalance may be adjusted. In particular, an adjustment may be made between first grid cells that are contained at least one epicenter of epicenters of historical earthquakes and second grid cells that did not contain at least one epicenter of the plurality of epicenters of the historical earthquakes.

The vector may be adjusted by adding additional features and values. For example, generating the vector may further include adding, to the vector, Riedel shear-stress projections on a set of lineaments in the underground target region. In another example, generating the vector may further include adding, to the vector, a prevalence of karst derived from semi-regional 3D seismic interpretations of the reservoir model.

FIG. 2.2 and FIG. 2.3 both show methods of predicting earthquakes and displaying the predictions of the earthquakes on a display device. The methods of FIG. 2.2 and FIG. 2.3 may be performed after the method of FIG. 2.1. The method of FIG. 2.2 and FIG. 2.3 may be performed using the system shown in FIG. 1.

Turning first to FIG. 2.2, Block 250 includes executing one or more trained machine learning algorithms, wherein each of the plurality of trained machine learning algorithms take, as input, a new vector including features and values representing a pressure distribution of grid cells of a target underground region. The new vector represents data regarding simulated new water being injected into disposal wells in the target underground region. Training may be performed as described with respect to FIG. 1.2, and according to the more specific details described with respect to FIG. 2.1.

Block 252 includes combining outputs generated by executing the trained machine learning algorithms to generate a combined output. The combined output represents probabilities of future earthquakes within the plurality of grid cells. For example, the probabilities generated by each machine learning algorithm may be combined on a grid cell basis. Thus, if five predictions are made for a specific grid cell, then the five predictions may be averaged together to generate one prediction for that specific grid cell. However, the predictions may be weighted, if desired, such as when it is known that a particular machine learning algorithm tends to be more accurate than another for a specific application.

In any case, the final combined output may be locations of predicted future earthquakes with each predicted future earthquake having a corresponding probability of occurrence that exceeds a predetermined threshold value. The pre-determined threshold value may be set by a geologist or may be set automatically by some rule or by a different machine learning algorithm programmed to determine an appropriate threshold value.

In another embodiment, it is possible to represent probabilities when the output is presented, and then optionally to highlight those grid cells where the probability of an earthquake exceeds the threshold value. Thus, presenting the combined output may include presenting a three dimensional map of the target underground region on a display device and indicating, on the three dimensional map, locations of the predicted future earthquakes.

For example, at block 254, the method may include displaying, on a display device, the combined output as a heat map that highlights each of the grid cells according to the probabilities of future earthquakes. The heat map presents probabilities as a variety of different colors, with predetermined probability ranges represented by colors or other highlighting on the heat map. The locations where the probabilities exceed the threshold value may be highlighted still further. Examples of heat maps are shown in FIG. 3.8 and FIG. 3.9.

The heat map may be further modified. For example, block 256 includes overlaying, on the heat map, icons that indicate corresponding locations of disposal wells. Each disposal well is a location where water could be injected back into the target underground region. For example, the disposal wells could be marked by circles, spheres, or other shapes which may be colored or otherwise highlighted.

Attention is now turned to FIG. 2.3. FIG. 2.3 represents a method similar to FIG. 2.2 but represents a different embodiment for presenting and then using the output of the machine learning algorithm (e.g., presenting and using the probabilities of earthquakes at each grid cell). More specifically, FIG. 2.3 may be characterized as a method for improving the reinjection of wastewater by minimizing the probabilities of earthquakes that may result from reinjection of the wastewater.

Thus, block 260 and block 262 of FIG. 2.2 are the same as block 250 and block 252 of FIG. 2.1. Accordingly, see the description of FIG. 2.1 for block 260 and block 262 of FIG. 2.2.

After block 262, block 264 includes recursively performing a set of operations until a minimal set of predicted future earthquakes is generated. The minimal set of predicted future earthquakes may be at least one of a minimum number of predicted earthquakes or a minimum severity of predicted earthquakes being predicted.

The set of operations may include adjusting the new vector to an adjusted vector by adjusting at least one of wastewater injection pressures and locations of wastewater injections in disposal wells in the target underground region. Then, the set of operations include generating a new combined output by executing the trained machine learning algorithms on the adjusted vector. Generating the outputs may be performed using the method of FIG. 2.1.

The set of operations also include determining whether the minimal set of predicted future earthquakes is achieved. For example, after generating many different scenarios (e.g., the predicted earthquakes for each of many different sets of variables for the water reinjection locations and pressures), a geologist may determine that it is unlikely that still newer reinjection scenarios would be likely to produce a minimal set of predicted future earthquakes. In this case, the minimal set of predicted future earthquakes is the set of variables that are input to the machine learning algorithm which result in the minimum predicted future earthquakes (either in terms of frequency or severity, or perhaps in terms of the locations of the earthquakes avoiding certain areas in which earthquakes would be considered particularly undesirable).

In another example, the set of operations may include automatically generating new reinjection variables and generating scenarios until convergence. In this case, convergence is not convergence in the machine learning algorithm, but rather a certain number of reinjection variables and scenarios have been used to generate predictions of earthquakes, and no new prediction occurs that is less than some already determined scenario. The already determined scenario is then deemed to be the minimal set of predicted future earthquakes. The variables used for that already determined scenario will be used in the next block.

Block 266 includes generating, responsive to a determination that the minimal set of predicted future earthquakes is achieved, a wastewater disposal plan using the minimal set of predicted future earthquakes. For example, the plan may include instructions for injecting wastewater at each of many different injection wells. Each injection well may receive different parameters for the reinjection of the wastewater. The parameters may include pressure, volume, reinjection rate, reinjection location within the target underground region, and possibly other parameters.

Block 268 then includes implementing the wastewater disposal plan by injecting the wells with wastewater according to the wastewater disposal plan. Implementing the wastewater disposal plan may be performed by adjusting physical water injection equipment located at each well cite in accordance with the wastewater disposal plan. Thus, each wastewater well site will physically reinject the wastewater into the earth at the water pressure, volume, rate, location, etc. called for by the wastewater disposal plan at that particular disposal well.

FIG. 2.4 shows a diagram of a machine learning framework that may be used. As shown in FIG. 2.4, sensors (1100) obtain various property values of properties in the field (e.g., target reservoir). Property values include, for example, pore pressure, surface top, temperatures, permeability, and other physical properties of the reservoir.

Additionally, uncertainty parameters (1104) may be provided that include ranges of the physical properties. Namely, where physical properties may not be known, the uncertainty parameters provide the ranges for which the physical properties may exist. Historical injection data is also provided to the system.

An ensemble model (1102) creates an ensemble of realizations from the measured properties and the uncertainty parameters.

A realization is a grid of cells with various values for the physical properties. Each of the various values are within the ranges set by the uncertainty parameters. Thus, each realization corresponds to a possibility of the underground properties of the target region. The collection of realizations spans various possibilities. For example, one realization may make a first assumption regarding the porosity in a particular cell while another realization may make a different assumption, whereby both assumptions are in the range defined by the uncertainty parameters for the porosity.

Thus, the ensemble model (1102) is a model of the target underground region. Accordingly, the ensemble model may be an ensemble of two or more of the reservoir models described with respect to FIG. 1.1 (e.g., the reservoir model (102)).

Earthquake positioning data indicate the seismicity emanating from deep crystalline rock layers below the stratigraphic section. The purported mechanism for the seismicity is lubrication of deep basement faults as a result of induced pore pressure in deeper saltwater disposal (SWD) units caused by injection of saltwater. The machine learning framework of FIG. 2.4 characterizes formation pressure as a result of SWD and characterizes seismic potential as a result of varying saltwater injection scenarios.

One or more embodiments may use geo-cellular modelling to account for reservoir heterogeneity. Machine learning based stratigraphic facies modelling is used to generate an ensemble of porosity-permeability realizations, and structural features like faults and fractures are accounted for using commercially available geomodelling software.

The ensemble model (1102) may be used by an Embedded Model Estimator (EMBER) algorithm, which is based on an embedding of geostatistical prior models. The EMBER algorithm may be a data-driven approach capable of handling many input variables to provide additional conditioning of the ensemble model (1102).

A predictor may then re-weigh the importance of the variables in different parts of the field to adapt local heterogeneity. Further, the ensemble model (1102) may handle trends like variables in the estimation process without performing transformations. FIG. 2.8 shows an example ensemble model.

Continuing with FIG. 2.4, the realizations may be passed to a reservoir simulator (1106) that simulates the underground formations under various injection conditions. For example, the reservoir simulator may simulate the resulting pressures from performing the simulations.

The simulated realizations may be passed to a matching algorithm (1110) that combines the simulations with historical information describing seismic data. The seismic data identifies the locations within the target region in which a seismic event occurred and the magnitude of the seismic event. The seismic data has a collection of seismic events for the target region.

The simulated realizations are individually associated with the collection of seismic events. For example, each of the realizations may be associated with the collection. The association relates the magnitudes and locations of the seismic events with the cells in the simulated realizations matching the locations. Thus, pressures of the simulated realizations are related to the seismic events.

The simulated realizations with the seismic event data are passed from the matching algorithm (1110) to the machine learning algorithm (1114). Specifically, the simulated realizations with the seismic event data are used to train the machine learning algorithm (1114).

The machine learning algorithm may be a neural network, a regression model, a tree based model, or another model. For example, a regression model may be used that performs multivariate logistic regression. As another example, a neural network may be used that classifies features extracted from a new scenario to classes including no seismic event to different ranges of seismic magnitudes.

The machine learning algorithm (1114) is connected to an interface (1116) (e.g., an user interface or an application programming interface). The interface provides one or more new injection scenarios (1118) for a target region. The injection scenarios are passed to the reservoir simulator to simulate the resulting pressures for the different realizations.

The machine learning algorithm (1114) then uses the simulated realizations to generate an uncertainty map (1120) describing seismic probabilities for different regions based on the resulting pressures. Namely, each location in the uncertainty map shows the probability and magnitude (e.g., class) of the seismic event for that location. The probability for the location spans the various realizations.

By performing the operations over multiple injection scenarios, optimization is performed that maximizes injection amounts while minimizing seismic event probabilities. The injection scenarios include injection amount(s), injection rate(s), injection location(s), and other injection related information.

FIG. 2.5 and FIG. 2.6 show different embodiments of methods for training a machine learning algorithm to predict earthquakes, or for predicting earthquakes using trained machine learning algorithms. The methods of FIG. 2.5, FIG. 2.6, and FIG. 2.7 may be executed using the system of FIG. 1.1 and FIG. 1.2, or the computing system and network environment shown with respect to FIG. 4.1 and FIG. 4.2. FIG. 2.8 shows an example ensemble model, in accordance with one or more embodiments.

Attention is turned to FIG. 2.5. An ensemble of realizations for a target region is generated that relates reservoir pressure to water injection in Block 1201. The ensemble of realizations may be the reservoir model (102) in FIG. 1.1 and may be received in a similar manner.

In Block 1203, a machine learning algorithm is trained that relates the ensemble to seismic activity. Training may be performed as described with respect to FIG. 1.2 and FIG. 2.1.

In Block 1205, the trained machine learning algorithm is used to forecast the probability of a seismic event based on a water injection scenario. The forecasting may be performed as described with respect to predicting the probabilities in FIG. 2.2 or FIG. 2.3.

Attention is now turned to FIG. 2.6. A three dimensional grid of cells for a target underground region is created in Block 1301. The grid of cells may be created by virtually dividing the underground target region into a grid of volumes that subdivide the underground target region.

In Block 1303, an ensemble of porosity and permeability grid property realizations capturing uncertainty using a property modelling engine is generated. The ensemble may be generated by combining two or more different reservoir models, such as the reservoir model (102) of FIG. 1.1.

In Block 1305, history matching on the ensemble is performed to simulate induced reservoir pressure from historic injection data to obtain simulated realizations. The history matching is performed by extrapolating how induced reservoir pressure will be changed based on prior measurements of past water injection in the target underground region.

In Block 1307, seismic event and subsurface structural feature data is obtained. The data may be obtained by retrieving a history of past earthquakes. The feature data may be read from the ensemble model.

In Block 1309, seismic event and subsurface structural feature data is matched to simulated realizations. The prior event and feature data may be matched to the simulated realizations by comparing the past values to the grid cells, and extrapolating how the simulated realization would result in a change to the past values.

In Block 1311, the machine learning algorithm is trained using the matched realizations. The machine learning algorithm may be trained using the techniques described with respect to FIG. 1.2 and FIG. 2.1.

FIG. 2.7 shows a flowchart for using the trained model. Water injection scenarios are forecasted based on realizations into injection strategy cases in Block 1401. The water injection scenarios are the new models described above.

In Block 1403, the injection strategy cases are filtered to those that maximize injection rates and remain below pressure thresholds for seismic events. Filtering may be performed by excluding or removing those scenarios which do not satisfy the injection rates and pressure thresholds.

In Block 1405, the filtered responses are processed by the machine learning algorithm to generate seismic response probability maps. Block 1405 is similar to presenting the probabilities of future earthquakes, as described with respect to FIG. 2.2 and FIG. 2.3.

Based on the seismic response probability maps, an injection strategy is selected that minimizes seismic events or the effects of a seismic event in Block 1407. The injection strategy may be generated in a manner similar to generating the wastewater disposal plan in block 266 of FIG. 2.3.

FIG. 2.8 shows an example of an ensemble model (280). Each of row (282), row (284), and row (286) represent different information from one or more reservoir models. Additional information from porosity data (288) and one or more embedded geostatistical models (290) may be added to the ensemble model (280). The gathered information is combined into the ensemble model (280) and then used for simulation (292).

While the various blocks in the flowcharts of FIG. 2.1, FIG. 2.2, FIG. 2.3, FIG. 2.5, FIG. 2.6, and FIG. 2.7 are presented and described sequentially, at least some of the blocks may be executed in different orders, may be combined or omitted, and at least some of the blocks may be executed in parallel. Furthermore, the blocks may be performed actively or passively.

FIG. 3.1 through FIG. 3.11 represent a specific example of one or more embodiments in use. The following example is for explanatory purposes and not intended to limit the scope of one or more embodiments. The example of FIG. 3.1 through FIG. 3.11 may be implemented using the system shown in FIG. 1.1 and FIG. 1.2 and using the techniques described with respect to FIG. 2.1 through FIG. 2.8.

As indicated above, produced water disposal is a challenge associated with oil and gas operations. One technique to dispose of produced water is through water reinjection in the subsurface.

However, reinjection can lead to an increase in the pressure in the formation used for disposing produced water and can result in increased earthquake activity. The increased activity can have an impact on the environment and add uncertainty to design and planning decisions.

Attention is turned to FIG. 3.1. FIG. 3.1 shows a simplified stratigraphic column (300) in an area of interest in the northern Midland Basin in the state of Texas of the United States of America. The columns represent age, sub-age, and the subsurface layers of the Earth at the Midland Basin. Structural interpretation of the three dimensional seismic area focused on the Strawn seismic formation (302) and underlying strata. Seismic attribute work identifying karst facies was performed on stratal slices between the Strawn formation (302) and the Ellenburger formation (304). A reservoir model was built for the upper portion of the Ellenburger formation (304). Most earthquake hypocenters that were reported are positioned in the basement (306) of the target underground region (the lower Paleozoic/basement section).

One or more embodiments described above, and the example provided below, may represent a hybrid method to understand the relationship between saltwater injection in the Ellenburger Formation (304) in the northern Midland Basin and associated earthquake activity. The hybrid method leverages petrotechnical and machine-learning based workflows to characterize earthquakes.

One or more embodiments may use information such as geocellular reservoir properties, reservoir simulation data, historical earthquake information, and proprietary semiregional 3D seismic data. A semiregional static reservoir model is constructed based on well control and facies maps. Porosity-permeability properties may be propagated using a machine learning assisted property modeling engine. One or more embodiments may use history matching to account for historic saltwater disposal in the Ellenburger formation (304) and model the induced pore pressure. The machine learning algorithm considered relevant features at each node (e.g., grid cell), such as reservoir pressure, proximity of known faults, karst features, and stress orientation.

As indicated above, one or more embodiments may use a hybrid method to holistically analyze reservoir data, along with injection information and three dimensional seismic data. One or more embodiments may leverage machine learning to extract insights from the historical earthquake data and the association of the earthquake data with reservoir conditions and fault traces. The predictions generated by one or more embodiments may substantiate the presence of deep fracture networks that may be causing pressure diffusion and are in line with earthquake observations away from faults assessed from three dimensional seismic data.

One or more embodiments may provide a tool to analyze historic data and generate, accordingly, an earthquake probability map. One or more embodiments may be used to as a guidance tool for planning injection wells and schedules.

The northern Midland Basin has seen a recent uptick of basement-fault-related seismic events, commonly referred to as induced seismicity, which correspond to increased industrial activity since the year 2017. Previous investigations in the Permian Basin have focused on characterizing earthquake focal mechanisms, poroelasticity, fault-slip potential, and multivariate statistical models. In this example, there is a focus on characterizing the relationship between induced pore pressure in the heterogeneous Ellenburger saltwater disposal units and observed seismicity in the northern Midland Basin. One or more embodiments may improve on prior earthquake prediction techniques via the incorporation of high-quality semiregional three dimensional seismic data for structural and stratigraphic interpretation, modeling of reservoir heterogeneity, and the coupling of physics-based reservoir simulation with multivariate statistics, machine learning, and optimization workflows.

Historically, the San Andres Formation of the northern Midland Basin has been suitable for saltwater disposal given the high porosity and low drilling and completion costs in these areas. However, incidences of drilling challenges and interference into lower productive units caused by over-pressuring has caused operators to seek other alternatives, such as the underlying Lower Ordovician (i.e., the Ellenburger formation (304)).

While drilling and completion costs of the Ellenburger formation (304) may be considerably higher because of its depth and the overlying pressure benches, the Ellenburger formation (304) is regionally extensive, known to have prolific karst facies of high injectivity index, and is sealed by overlying Permian mudrocks. These features make the Ellenburger formation (304) a suitable candidate for saltwater disposal.

Interpretation of three dimensional seismic data indicate a Lower Paleozoic structural system largely decoupled from the overlying Permian mudrocks. In this example, a focus is made on structural interpretation and earthquake seismicity of the basement (306).

Attention is turned to FIG. 3.2. FIG. 3.2 shows a process diagram (320) depicting elements of one or more embodiments. Three dimensional seismic interpretation is used as the basis for reservoir model construction (321) and feature engineering (322) that is passed to the multivariate classification model (323).

Underground injection control records and proprietary sources are used to construct wellbore models, calculate injectivity index and to history match the reservoir model. Reservoir pressure and the structural interpretation elements are scaled and passed to a machine learning pipeline to train a binary classification model for epicenter prediction. The trained model (324) can be used to generate seismic risk maps (325) and are the basis for saltwater disposal rate maximization schemes (326).

As indicated above, one or more embodiments may present a hybrid of a traditional petrotechnical and a data science workflow where features such as basement structuring and disposal unit pressure are derived from semiregional three dimensional seismic interpretation, geocellular property modeling, and reservoir simulation. These features are subsequently fed into multivariate machine learning engines for the purpose of earthquake risk characterization. The generated workflow is thereafter also used to run different simulations based on different in puts, in order to generate an optimized scenario which minimizes one or both of earthquake risk and earthquake severity after implementing a saltwater disposal plan.

Data used for the analysis included wellbore information such as top and base of injection zone, monthly data on fluid volumes, and maximum and average injection pressures. Earthquake data were obtained from public sources. In addition to public sources, proprietary datasets were used for obtaining regional three dimensional seismic data.

Attention is turned to FIG. 3.3. FIG. 3.3 shows a Hall diagnostic plot (330) divided into injectivity index segments (dashed lines (332)) using a linear tree regressor machine learning algorithm. The high-rate injection well demonstrates high injectivity index in underfilled karst zones and progressive filling of tighter pore volumes and possibly increasing completion skin.

The Hall diagnostic plot (330) was used to assess reservoir injectivity. The hall diagnostic plot (330) is a graphical representation of the pressure response of a well to injection, which helps to identify the main factors affecting the well's performance, such as reservoir heterogeneity and wellbore damage. The plot shows the aggregate daily-weighted injection pressure versus cumulative injection volume. Given the large number of injection wells in the target underground region, a linear tree regressor machine learning algorithm was used to automatically flag poor data, interpret flow regimes, and calculate estimates of reservoir injectivity index. The calculated reservoir injectivity index was then employed for calibrating the reservoir model.

Attention is turned to FIG. 3.4. FIG. 3.4 shows a Ordovician stratal slice (340). The seismic curvature attribute in the Ordovician stratal slice (340) demonstrates the presence of karst zones (circular features near arrow (341) and structural faults (linear features shown by the arrow (342)). Arrow (342) indicates north.

In this example, the semiregional 3D seismic data was used to interpret stratigraphic horizons and structural faults in the reservoir. The analysis was used to generate facies maps that further informed the reservoir simulation model.

Because of the structural complexity of the Lower Paleozoic in the Midland Basin, image-segmentation-based, machine learning assisted fault-interpretation methods were used to generate fault pointsets. This analysis indicated that the deep faults within the target underground region may be dipping steeply (angled at greater than 65° relative to the direction of gravity).

Machine learning assisted fault interpretation was used to process the semiregional 3D seismic data and to identify small branch faults, subtle juxtapositions, and radial karst faults in the dataset. In addition, the process leveraged curvature attributes to extract karst facies from the seismic dataset. Seismic curvature attributes were used to identify karst features on stratal slices in the Ordovician (see FIG. 3.4). Karst features were used to identify reservoir facies and were used as a feature in the multivariate earthquake prediction model. While structural faults are manifest on the curvature attributes, the fault point artifacts from the machine learning assisted fault interpretation were used to delineate structural faults.

Attention is turned to FIG. 3.5. To generate Ellenburger reservoir model layers, a facies model (350) was used as a first-order guide. The generated Ellenburger model up section was extended into the Simpson Group and into the non-reservoir Lower Ellenburger.

The reservoir model was subsequently populated with grid faults, and local grid refinements were carried out near complex faults in the model. Except for the local grid refinements, the base grid size in the reservoir simulation was set at 1000 feet by 1000 feet by 1000 feet.

To calibrate fault transmissibility, permeability anisotropy, and reservoir properties, injectivity index estimates were used. The injectivity index estimates were generated from the linear tree regressor machine learning algorithm and also employed history-matching workflows.

For the simulation, the Ellenburger Formation was assumed to be normally pressured at initial conditions and was saturated with high-salinity brine. To ensure stability of the reservoir model while simulating flow of a slightly compressible fluid in a saturated reservoir, a large numerical aquifer is used at the model boundaries. In this manner, a pressure distribution in the reservoir was calculated as salt water was injected into the associated disposal wells. The increased induced reservoir pressure caused by the injection of salt water was then used to characterize earthquake risk in the region using the machine learning algorithm. (See FIG. 2.1 and FIG. 2.2.)

Attention is turned to FIG. 3.6. FIG. 3.6 shows a representative history match (360) of a semiregional Ellenburger reservoir model. Average monthly tubinghead pressures from available records are converted to flowing bottomhole pressures and are used as a guide to tune hydraulic properties of the reservoir model. The hydraulic properties include grid cell poro-perm, fault transmissibility, and aquifer size.

The machine learning algorithm trained according to the techniques described with respect to FIG. 1.2 and FIG. 2.1 was used to build and deploy a multivariate classification scheme to characterize earthquake risk. The fundamental unit of analysis in the constructed pipeline was the reservoir model grid cell. Data were aggregated monthly into cells and two features were extracted from the aggregated data: reservoir pressure of the grid and the distance of the grid to lineament set. The calculated features were then scaled and passed into the modeling framework.

In the workflow, earthquake data were filtered to exclude earthquakes from the study that occurred at depths shallower than the base of the Permian section. The remaining deeper earthquake epicenters were aggregated to the nearest reservoir grid cell in the reservoir model.

The processed dataset was split into a training/testing set stratified on the class label of earthquake/no earthquake to use in the model training workflow. As earthquake occurrence data were spatially skewed in our reservoir model, class weighting was applied to the dataset during the model training to adjust for the imbalance. It was observed that the reservoir simulation grid had a 400:1 imbalance between grid cells that did not contain an epicenter and grid cells that did contain an epicenter.

To develop the trained machine learning algorithm, a systematic study was conducted to understand the performance and applicability of various classification models on the problem of characterizing earthquakes. It was observed that tree-style schemes may overfit the training data. It was found that multivariate logistic regression and a three-layer neural network may be used (in one embodiment) for addressing the problem. The multivariate logistic regression may result in a smoother prediction kernel while the neural network emphasizes the local features, such as the lineament trends. The outputs of the two machine learning algorithms were combined to produce a final classification that can be more robust and accurate than the predictions of these two individually.

Attention is now turned to FIG. 3.7, which shows a quantitative assessment of the performance of then combined (ensemble) machine learning technique. In particular, FIG. 3.7 shows a receiver operating characteristic (ROC) graph (370), that can be used to evaluate the test dataset of the earthquake binary classification scheme. The area under curve (AUC) scores are shown as the logistic regression AUC score (372) and the neural network AUC score (374). Both models are trained on the same six input features. The three-layer neural network machine learning algorithm has slightly higher accuracy and emphasizes the basement lineament set more than the logistic regression machine learning algorithm.

Some past earthquake predictions were based on deterministic Mohr-Coulomb-style fault-slip potential (DFSP). In the determinist DFSP, the unit of analysis is a given fault plane within a background stress field. DFSP depends on estimates of reservoir pressure, internal friction of the material, and knowledge of the principal stresses acting on the fault plane. In practice, rigorous geomechanical modeling is limited by lack of relevant data acquisition such as borehole image logs, dipole sonic, leakoff tests, and formation pressure measurements that are used to estimate the principal stresses and rock strength along a one dimensional wellbore and, by extension, within a semiregional three dimensional area of interest.

One or more embodiments may overcome these technical problems. Specifically, the relevant geomechanical properties are inferred by linking engineered features (such as reservoir pressure, distance to a basement lineament, Riedel shear-stress projection on the lineament set, and prevalence of karst that are derived from semiregional 3D seismic interpretation) with historic earthquake events.

The results of the earthquake prediction techniques described herein are shown in FIG. 3.8 and FIG. 3.9, which are examples of heat maps (i.e., heat map 380 in FIG. 3.8 and heat map 382 in FIG. 3.9). The machine learning algorithm was trained to identify subsurface conditions correlated with earthquake events. Partial dependency plots demonstrate earthquake probability is the highest for grid cells 1) that are not associated with a karst feature, 2) are above a pressure threshold, and 3) are near a basement lineament oriented along a Riedel shear set implied by a N90°E principal displacement zone, which is consistent with SHmax in the northern Midland Basin.

The highlighting shown in FIG. 3.8 and FIG. 3.9 represent the probabilities of earthquakes calculated at grid cells of the reservoir model. Dots (e.g., dot (383) and dot (384)) are the epicenters of historical earthquakes. Injection wells are indicated with the circles (e.g., circle (385) and circle (386)). Arrow (387) indicates north.

The classification probability can be interpreted as a seismic risk map indicating the similarity of conditions historically associated with earthquake epicenters and the conditions of the cells of the reservoir model for the given timestep. FIG. 3.8 shows an earthquake swarm in the vicinity of three injection wells from the northern part of the target underground region. The map indicates earthquake positions concentrated along a pressurized lineament set. The arrow annotated “K” (388) indicates the presence of a karst feature interpreted from seismic curvature attributes. In the target underground region, few earthquake epicenters are coincident with karsts (388).

FIG. 3.9 shows earthquake swarms concentrated along a structural fault zone. More intense highlighting indicates relative high reservoir pressure (relative to the pressure in other areas of the reservoir) along the basement lineament set in the vicinity of the two active injection wells. The arrow annotated “L1” (389a) shows a preferentially oriented lineament, whereas the arrow annotated “L2” (389b) shows a non-preferentially oriented lineament. The arrow annotated “NL” (389c) shows an area away from a basement lineament (not lineament). Like in FIG. 3.8, karsts (388) are shown in as similarly highlighted areas.

Attention is turned to FIG. 3.10. FIG. 3.10 shows a process model (390) consistent with the observations made in the example of FIG. 3.1 through FIG. 3.9. Pressuring of the Ellenburger in the vicinity of basement lineaments is correlated with basement seismicity in the northern Midland Basin.

Most earthquake hypocenters in the dataset are positioned below the base of the Paleozoic section, which is between 12,000 and 14,000 feet in the target underground region. However, the reservoir pressure was modeled, and faults were picked in the Paleozoic section. It appears that structural faults transmit pressure into deeper basement layers which, in turn, induces fault slip (see FIG. 3.10).

It was observed that in some areas of the three dimensional seismic footprint, earthquake epicenters are consistent with the presence of a Paleozoic fault system. However, in some areas there are linear earthquake swarms that are not associated with a nearby structural fault. In addition, it was observed that these linear earthquake swarms were on trend with a mapped fault set.

Following a similar lineament mapping methodology often employed to infer joints, faults, and shear zones in the subsurface based on topographic maps, a basement lineament set was generated by connecting on-trend fault segments mapped in the Lower Paleozoic. To generate the basement lineament set, a Hough transform (commonly used for edge detection in image processing) was used to quantitatively generate the lineament set from the fault interpretation points. It was observed that as a predictive feature, the lineament set is effective in predicting both earthquake epicenters in the vicinity of a mappable Paleozoic fault plane and linear earthquake swarms not directly associated with a mappable fault plane.

In the context of the multivariate classification machine learning algorithm, the basement lineament set is capturing implied hydraulic properties of a discrete fracture network (DFN) of high permeability and low storage porosity. In the multivariate machine learning algorithm, earthquake probability increases on a preferentially oriented lineament that is coincident with high pore pressure in the overlying Ellenburger Group caused by water injection. Grouping the Ellenburger and Basement as a common geomechanical unit in the current tectonic stress regime, the lineament set indicates planes of strain connected by preexisting weaknesses in the rock fabric of the basement and Lower Paleozoic section.

Attention is turned to FIG. 3.11. FIG. 3.11 is a wastewater disposal plan (392), which in the example of FIG. 3.1 through FIG. 3.10, represents a saltwater disposal injection rate maximization scheme based on the trained multivariate classification machine learning algorithm. The highlighting represented at arrow (394) represents planned reservoir water injection pressure at grid cells along the fault (393). Highlighted streamlines (e.g., streamline 395) demonstrate flow away from the injection wells. Injection well rate, measured in increments of 1000 barrels of water per day, is labeled above each of the three injection wells (e.g., injection well (396), injection well (397), and injection well (398)). The maximum injection rate depended on the background reservoir pressure from historic injection, well spacing, distance to faults and lineaments, and presence of karst.

Given the trained multivariate classification machine learning algorithm, “what-if” (e.g., different model) forecasting and planning scenarios can be used to optimize saltwater disposal rates given the known proximity to a karst feature, basement lineament presence and orientation, and reservoir pressure while remaining below an induced seismicity risk tolerance. As indicated above, FIG. 3.11 shows the result of an injection rate maximization scheme in the vicinity of a structural fault.

The methodology presented herein may provide a tool to explain historic seismicity and to inform asset development planning, the regulatory permitting process, and interaction within adjacent operators and the saltwater disposal industry. One or more embodiments may use traditional seismic-to-simulation workflows as the basis for custom feature engineering that is passed into a multivariate classification machine learning algorithm. The machine learning algorithm, in turn, infers the probability of an earthquake epicenter occurring at a given grid cell in a semiregional reservoir model (the target underground region).

It was found that grid cells with higher pore pressure caused by water injection, proximity to a basement lineament preferentially oriented relative to a Riedel shear set, and not positioned at an Ellenburger karst, are more likely to coincide with an earthquake epicenter. One or more embodiments may take into consideration several factors. The factors include the incorporation of Ellenburger heterogeneity on a semiregional scale. The factors include characterization of a basement lineament set based on detailed mapping of three-dimensional seismic data. The factors include the imputation of relevant geomechanical features commonly used in a deterministic Mohr-Coulomb fault-slip potential (DFSP) analysis using machine learning algorithm workflows calibrated to historic earthquake data.

One or more embodiments may be implemented on a computing system specifically designed to achieve an improved technological result. When implemented in a computing system, the features and elements of the disclosure provide a technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 4.1, the computing system (400) may include one or more computer processor(s) (402), non-persistent storage device(s) (404), persistent storage device(s) (406), a communication interface (412) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) may be one or more cores or micro-cores of a processor. The computer processor(s) (402) includes one or more processors. The one or more processors may include a central processing unit (CPU), a graphics processing unit (GPU), a tensor processing units (TPU), combinations thereof, etc.

The input devices (410) may include a touchscreen, keyboard, mouse, microphone, touchpad, electronic pen, or any other type of input device. The input devices (410) may receive inputs from a user that are responsive to data and messages presented by the output device(s) (408). The inputs may include text input, audio input, video input, etc., which may be processed and transmitted by the computing system (400) in accordance with the disclosure. The communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

Further, the output devices (408) may include a display device, a printer, external storage, or any other output device. One or more of the output devices may be the same or different from the input device(s). The input and output device(s) may be locally or remotely connected to the computer processor(s) (402). Many different types of computing systems exist, and the aforementioned input and output device(s) may take other forms. The output devices (408) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (400) in FIG. 4.1 may be connected to or be a part of a network. For example, as shown in FIG. 4.2, the network (420) may include multiple nodes (e.g., node X (422), node Y (424)). Each node may correspond to a computing system, such as the computing system shown in FIG. 4.1, or a group of nodes combined may correspond to the computing system shown in FIG. 4.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422), node Y (424)) in the network (420) may be configured to provide services for a client device (426), including receiving requests and transmitting responses to the client device (426). For example, the nodes may be part of a cloud computing system. The client device (426) may be a computing system, such as the computing system shown in FIG. 4.1. Further, the client device (426) may include and/or perform at least a portion of one or more embodiments.

The computing system of FIG. 4.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and blocks shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited by the attached claims.

What is claimed is:

1. A method comprising:
receiving a reservoir model of a target underground region;
extracting, from the reservoir model, a historic pressure distribution in a plurality of grid cells of the target underground region;
extracting, from the reservoir model, a plurality of distances, each distance represents a distance between a grid cell in the plurality of grid cells and a corresponding lineament in the target underground region;
receiving historic earthquake data of a plurality of past earthquakes in the target underground region;
generating a vector including a plurality of features and a corresponding plurality of values for the plurality of features, the plurality of features includes at least i) the historic pressure distribution, ii) the plurality of distances, and iii) the historic earthquake data; and
training a trained machine learning algorithm by recursively executing a machine learning algorithm on the vector until convergence.

2. The method of claim 1, comprising:
receiving a new model of pressure distribution in the plurality of grid cells of the target underground region;
converting the new model into a new vector, the new vector includes a new pressure distribution in the target underground region;
executing the trained machine learning algorithm on the new vector, an output of the trained machine learning algorithm includes a future prediction of earthquakes in the target underground region; and
reporting the future prediction.

3. The method of claim 1, comprising:
training a plurality of additional trained machine learning algorithms by recursively training, with the vector and until convergence, a plurality of additional machine learning algorithms.

4. The method of claim 3, wherein the plurality of additional machine learning algorithms is selected from the group consisting of: a multivariate logistic regression machine learning algorithm, a neural network machine learning algorithm, a random forest machine learning algorithm, and a tree-based machine learning algorithm.

5. The method of claim 3, comprising:
receiving a new model of pressure distribution in the plurality of grid cells of the target underground region;
converting the new model into a new vector;
executing the plurality of additional trained machine learning algorithms on the new vector, a plurality of outputs of the plurality of additional trained machine learning algorithms includes a plurality of future predictions of earthquakes in the target underground region;
combining the plurality of future predictions to generate a combined prediction; and
reporting the combined prediction.

6. The method of claim 1, wherein generating the vector includes:
weighting the plurality of features to adjust for a grid imbalance between first grid cells that contained at least one epicenter of a plurality of epicenters of historical earthquakes and second grid cells that did not contain at least one epicenter of the plurality of epicenters of the historical earthquakes.

7. The method of claim 1, wherein generating the vector includes:
adding, to the vector, Riedel shear-stress projections on a set of lineaments in the underground target region.

8. The method of claim 1, wherein generating the vector includes:
adding, to the vector, a prevalence of karst derived from semi-regional 3D seismic interpretations of the reservoir model.

9. A method comprising:
executing a plurality of trained machine learning algorithms, each of the plurality of trained machine learning algorithms takes, as input, a new vector including features and values representing a pressure distribution of grid cells of a target underground region, and the plurality of trained machine learning algorithms each are trained by:
receiving a plurality of reservoir models of a target underground region,
extracting, from the plurality of reservoir models, a historic pressure distribution in a plurality of grid cells of the target underground region,
extracting a plurality of distances from the plurality of reservoir models, each distance represents a distance between a grid cell in the plurality of grid cells and a corresponding lineament in the target underground region,
receiving historic earthquake data of a plurality of past earthquakes in the target underground region,
generating a vector including a plurality of features and a corresponding plurality of values for the plurality of features, the plurality of features includes at least i) the historic pressure distribution, ii) the plurality of distances, and iii) the historic earthquake data, and
training a trained machine learning algorithm by recursively executing a machine learning algorithm on the vector until convergence;
combining a plurality of outputs generated by executing the plurality of trained machine learning algorithms to generate a combined output, the combined output represents a future prediction of future earthquakes within the plurality of grid cells; and
presenting the combined output.

10. The method of claim 9, wherein the combined output includes a plurality of locations of predicted future earthquakes, each predicted future earthquake has a corresponding probability of occurrence that exceeds a predetermined threshold value.

11. The method of claim 10, wherein presenting the combined output includes presenting a three-dimensional map of the target underground region on a display device and indicating, on the three-dimensional map, locations of the predicted future earthquakes.

12. The method of claim 9, wherein presenting includes:
displaying, on a display device, the combined output as a heat map that highlights each of the plurality of grid cells according to probabilities of future earthquakes.

13. The method of claim 12, comprising:
overlaying, on the heat map, a plurality of icons that indicate corresponding locations of a plurality of disposal wells.

14. The method of claim 9, comprising:
recursively performing a set of operations until a minimal set of predicted future earthquakes is generated, the minimal set of predicted future earthquakes includes at least one selected from a group consisting of a minimum number of predicted earthquakes and a minimum severity of predicted earthquakes being predicted, and the set of operations includes:
adjusting the new vector to an adjusted vector by adjusting at least one of wastewater injection pressures and locations of wastewater injections in a plurality of disposal wells in the target underground region,
generating a new combined output by executing the plurality of trained machine learning algorithms on the adjusted vector, and
determining whether the minimal set of predicted future earthquakes is achieved; and
generating, responsive to a determination that the minimal set of predicted future earthquakes is achieved, a wastewater disposal plan using the minimal set of predicted future earthquakes.

15. The method of claim 14, comprising:
implementing the wastewater disposal plan by injecting the plurality of disposal wells with wastewater according to the wastewater disposal plan.

16. A system comprising:
a processor;
a data repository in communication with the processor and storing:
a reservoir model of a target underground region,
a historic pressure distribution in a plurality of grid cells of the target underground region,
a plurality of distances, each distance represents a distance between a grid cell in the plurality of grid cells and a corresponding lineament in the target underground region,
historic earthquake data of a plurality of past earthquakes in the target underground region,
a vector including a plurality of features and a corresponding plurality of values for the plurality of features, the plurality of features includes at least i) the historic pressure distribution, ii) the plurality of distances, and iii) the historic earthquake data,
a plurality of probabilities that future earthquakes will occur in the plurality of grid cells of the target underground region, and
a new vector derived for the target underground region; and
a server controller which, when executed by the processor, performs a computer-implemented method including:
receiving the reservoir model,
extracting, from the reservoir model, the historic pressure distribution,
extracting, from the reservoir model, the plurality of distances,
receiving the historic earthquake data,
generating the vector, and
generating a trained machine learning algorithm by recursively executing a machine learning algorithm on the vector until convergence, the trained machine learning algorithm, when executed on the new vector, is programmed to predict the plurality of probabilities.

17. The system of claim 16, wherein the computer-implemented method, when the server controller is executed by the processor, comprises:
receiving a new model of pressure distribution in the plurality of grid cells of the target underground region for new water injected into a plurality of disposal wells in the target underground region;
converting the new model into the new vector, the new vector includes a new pressure distribution in the target underground region;
executing the trained machine learning algorithm on the new vector, an output of the trained machine learning algorithm includes a future prediction of earthquakes in the target underground region; and
reporting the future prediction.

18. The system of claim 16, wherein the computer-implemented method, when the server controller is executed by the processor, comprises:
training a plurality of additional trained machine learning algorithms by recursively training, with the vector and until convergence, a plurality of additional machine learning algorithms,
the plurality of additional trained machine learning algorithms, when executed on a new vector derived for the target underground region, are programmed to predict a plurality of sets of the plurality of probabilities that future earthquakes will occur in the plurality of grid cells of the target underground region.

19. The system of claim 18, wherein the computer-implemented method, when the server controller is executed by the processor, comprises:
receiving a new model of pressure distribution in the plurality of grid cells of the target underground region for new water injected into a plurality of disposal wells in the target underground region;
converting the new model into the new vector;
executing the trained machine learning algorithm and the plurality of additional trained machine learning algorithms on the new vector, a plurality of outputs of the trained machine learning algorithm and the plurality of additional trained machine learning algorithms includes a plurality of future predictions of earthquakes in the target underground region;
combining the plurality of future predictions to generate a combined prediction; and
reporting the combined prediction.

20. The system of claim 16, wherein the computer-implemented method, when the server controller is executed by the processor, comprises:
weighting the plurality of features to adjust for a grid imbalance between first grid cells that contained at least one epicenter of a plurality of epicenters of historical earthquakes and second grid cells that did not contain at least one epicenter of the plurality of epicenters of the historical earthquakes;
adding, to the vector, Riedel shear-stress projections on a set of lineaments in the underground target region; and
adding, to the vector, a prevalence of karst derived from semi-regional 3D seismic interpretations of the reservoir model.
